(19) United States
(12) Patent Application Publication
(10) Pub. No.: US 2013/0092415 A1
(43) Pub. Date: Apr. 18, 2013

(54) CABLE, METHOD OF MANUFACTURING THE SAME, AND APPARATUS FOR DEPOSITING DIELECTRIC LAYER

(71) Applicants: Yong Suk YANG, Daejeon (KR); In-Kyu YOU, Daejeon (KR); Jae Bon KOO, Daejeon (KR); Soon-Won JUNG, Daejeon (KR)

(72) Inventors: Yong Suk YANG, Daejeon (KR); In-Kyu YOU, Daejeon (KR); Jae Bon KOO, Daejeon (KR); Soon-Won JUNG, Daejeon (KR)

(73) Assignee: ELECTRONICS AND TELECOMMUNICATIONS RESEARCH INSTITUTE, Daejeon (KR)

(21) Appl. No.: 13/619,066

(22) Filed: Sep. 14, 2012

(30) Foreign Application Priority Data
Oct. 13, 2011 (KR) 10-2011-0104377

(51) Int. Cl. H01B 13/00; H01B 3/30

(52) U.S. Cl. 174/116; 427/58; 118/724

(57) ABSTRACT

The inventive concept provides cables, methods of manufacturing the same, and apparatuses for depositing a dielectric layer. The cable may include a first electrode, a second electrode spaced apart from the first electrode, and a dielectric layer disposed between the first and second electrodes and including a polymer having xylene as a monomer.

### CROSS-REFERENCE TO RELATED APPLICATIONS

This U.S. non-provisional patent application claims priority under 35 U.S.C. §119 to Korean Patent Application No. 10-2011-0104377, filed on Oct. 13, 2011, the entirety of which is incorporated by reference herein.

### BACKGROUND

The inventive concept relates to cables, methods of manufacturing the same, and apparatuses for depositing a dielectric layer and, more particularly, to low voltage differential signaling (LVDS) cables, methods of manufacturing the same, and apparatuses for depositing a dielectric layer.

Modern digital devices have been developed for satisfying various user requirements such as access to various techniques, fast information processing speed, and portability and access for using anytime and anywhere. Thus, integration and miniaturization techniques of the digital circuits may be developed based on a high speed technique for fast information processing. For keeping up with this tendency, a signal transfer speed of the digital circuits has been increased to several GHz, and a level of a supply voltage has been lowered for driving various devices by a limited power supply. A digital clock signal having the low voltage level and a short period may have a short rising time/a short falling time. This means that a power spectrum of the digital signal is distributed throughout a wide band.

A high performance display such as a Three-dimensional tin film transistor-liquid crystal display (3D TFT-LDC) may also require a high speed series communication. Interface between modules for the high speed series communication may adopt a point-to-point connection that a transmitting chip one-to-one corresponds to a receiving chip. And a transmission channel may be a cable.

A signal may be transmitted in a series small signal differential signal. Thus, high speed, low power consumption, low electromagnetic interference (EMI) of the communication may be realized as compared with a signal transmitted in parallel in a CMOS level. Particularly, the number of transmission lines through which signals are transmitted may be reduced. In other words, the number and sizes of the cables and others parts may be reduced to decrease costs.

Low voltage differential signaling (LVDS) may be widely used as the interface between the modules. The LVDS may have an insulating characteristic of 100 MΩ or more between lines, a contact resistance characteristic of 40 MΩ or less, a cable differential impedance of 100±10Ω. The LVDS may be used in a note book computer, a high definition (HD) LCD television, and a multifunction printer. A physical layer protocol (PHY) circuit of the LVDS interface will be described briefly. A transmitter circuit may consist of a current sink and four switches. The current sink may change a current by a current source and a common mode feed-back (CMFB). The CMFB circuit may maintain a common mode voltage of the small signal differential signal. If two of the four switches are selected by a data signal and opened, a current of 3.5 mA is transmitted through the transmission line and then is finished by a resistance of 100Ω at a front end of a receiver, thereby forming a small signal voltage of 350 mV. A comparator restores the small signal voltage in the CMOS level. Alternatively, if the other two of the four switches are selected, a direction of a current flow may be changed to form a small signal voltage having polarities opposite to those of the small signal voltage described above at both ends of the finish resistance. Thus, a signal of logic ‘0’ or logic ‘1’ may be determined.

Additionally, researches and developments have been conducted for a high-definition multimedia interface (HDMI) mode or a display port mode for being replaced with a conventional interface between modules. The HDMI mode or the display port mode may include image data and voice signals, be applied with a packet mode, and support bidirectional communication.

In development from an initial LVDS to the display port, a function of the interface has been expanded to transmit the voice signals as well as the image data, a transmission speed between differential input terminals has been increased, and data and a clock have been transmitted together for removing a clock which was additionally constituted.

Various noise problems may occur in variety and function-expansion of the high speed digital signal transmission through the LVDS. Particularly, an EMI problem occurring in a signal transmission process in a flexible flat cable (FFC) may cause distortion, crosstalk, and inter-symbol interference (ISI) of the signal when massive data are transmitted. Thus, operation characteristic of the digital circuit may be deteriorated.

### SUMMARY

Embodiments of the inventive concept may provide cables having excellent electrical characteristics.

Embodiments of the inventive concept may also provide methods of manufacturing the cable.

Embodiments of the inventive concept may provide apparatuses for depositing a dielectric layer of the cable.

In one aspect, a cable may include: a first electrode; a second electrode spaced apart from the first electrode; and a dielectric layer disposed between the first and second electrodes, the dielectric layer including a polymer having xylene as a monomer.

In some embodiments, the dielectric layer may include the polymer having at least one of p-xylene, monochloro-p-xylene, and dichloro-p-xylene as the monomer.

In other embodiments, the dielectric layer may have a thickness within a range of about 10 μm to about 50 μm and a resistivity of about 10¹⁶ Ωcm or more.

In another aspect, a method of manufacturing a cable may include: preparing a first electrode; decomposing xylene dimer into xylene monomers to provide the xylene monomers on a surface of the first electrode; forming the xylene monomers into a polymer on the surface of the first electrode, thereby forming a dielectric layer including the polymer; and forming a second electrode on a surface of the dielectric layer.

In some embodiments, decomposing the xylene dimer may include: thermally decomposing the xylene dimer at a temperature within a range of about 650 degrees Celsius to about 700 degrees Celsius to form the xylene monomers. The xylene dimer may include at least one of p-xylene dimer, monochloro-p-xylene dimer, and dichloro-p-xylene dimer.

In other embodiments, the method may further include: cooling the first electrode to a temperature within a range of about −25 degrees Celsius to about 25 degrees Celsius.

In still another aspect, an apparatus for depositing a dielectric layer may include: a heating block including a reactant injection hole into which a reacting fluid is provided, an insertion hole connected to the reactant injection hole, and a heating tool, wherein an object is disposed in the insertion hole; and a cooling block disposed to be adjacent to the heating block and including a cooling tool. The insertion hole may extend into the cooling block; and a deposition space may be defined in a region where the reactant injection hole meets the insertion hole.

In some embodiments, the reactant injection hole may have a shape tapered toward the deposition space.

In other embodiments, the reacting fluid may be provided into the reactant injection hole with carrier gas.

In still other embodiments, the heating tool may include a plurality of wires; the wires adjacent to the deposition space may be heated to a first temperature; and the wires adjacent to an end of the reactant injection hole and an end of the insertion hole may be heated to a second temperature lower than the first temperature.

In yet other embodiments, the cooling tool may include cooling water or a peltier device.

In yet still other embodiments, the cooling block may be disposed within the heating block. In this case, the apparatus may further include: a thermal insulating material disposed between the cooling block and the heating block.

In yet still other embodiments, the apparatus for depositing the dielectric layer may be provided in plural; and the plurality of the apparatuses may be disposed on the object and are spaced apart from each other.

In yet still other embodiments, the reactant injection holes respectively included in the plurality of the apparatuses may be connected to each other.

### BRIEF DESCRIPTION OF THE DRAWINGS

The inventive concept will become more apparent in view of the attached drawings and accompanying detailed description.

FIG. 1A is a perspective view illustrating a cable according to some embodiments of the inventive concept;

FIG. 1B is a cross-sectional view taken along a line I-I′ of FIG. 1A;

FIGS. 2A to 2C are cross-sectional views illustrating cables according to other embodiments of the inventive concept;

FIG. 3A is a flow chart illustrating a method of manufacturing a cable according to some embodiments of the inventive concept;

FIG. 3B illustrates a chemical mechanism of a dielectric layer including p-xylene according to some embodiments of the inventive concept;

FIGS. 4A to 4C are cross-sectional views illustrating dielectric layer-deposition apparatuses according to some embodiments of the inventive concept; and

FIG. 5 is a cross-sectional view illustrating a dielectric layer-deposition apparatus according to other embodiments of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

### Cable, First Embodiment

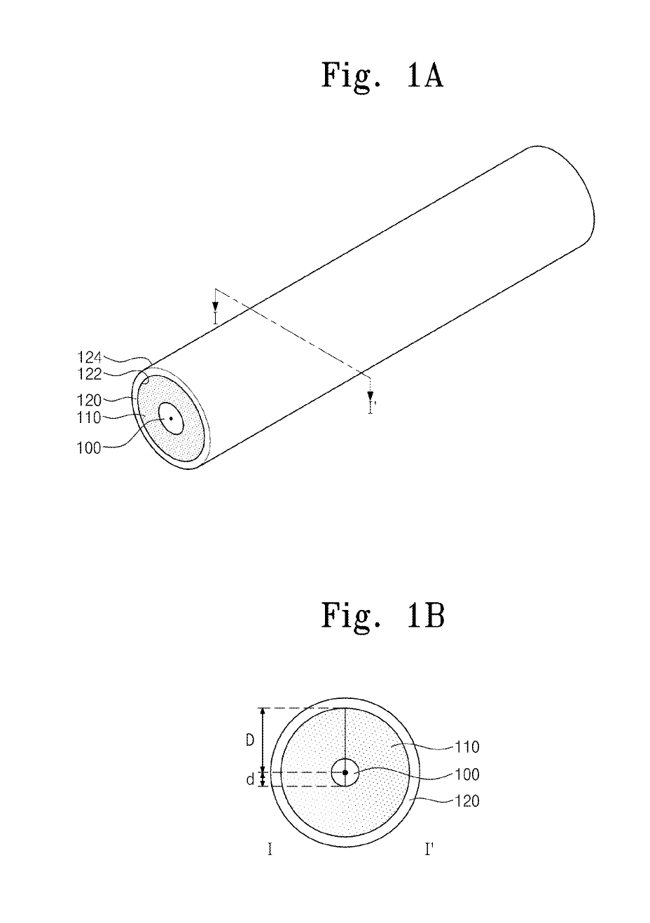

FIG. 1A is a perspective view illustrating a cable according to some embodiments of the inventive concept, and FIG. 1B is a cross-sectional view taken along a line I-I′ of FIG. 1A.

Referring to FIGS. 1A and 1B, a cable may have a cylinder-shape and extend in one direction. The cable may include a first electrode 100, a second electrode 120, and a dielectric layer 110 disposed between the first electrode 100 and the second electrode 120.

The first electrode 100 may have a circular cross section having a first diameter d. Additionally, the first electrode 100 may have a cylinder-shape extending in the one direction. The first electrode 100 may include a conductive material including copper and/or aluminum. In some embodiments, the first electrode 100 having the cylinder-shape may be completely filled with the conductive material. In other embodiments, the first electrode 100 may have flexibility.

The second electrode 120 may be spaced apart from the first electrode 100 and surround the first electrode 100. The second electrode 120 may have a cross section of a ring-shape. Additionally, the second electrode 120 may have a cylinder-shape extending in the one direction. The second electrode 120 may include an inner surface 122 adjacent to the first electrode 100 and an outer surface 124 spaced apart from the inner surface 122. In some embodiments, each of cross sections of the inner surface 122 and the outer surface 124 of the second electrode 120 may have a circular shape and have substantially the same center as the cross section of the first electrode 100. Additionally, the inner surface 122 of the second electrode 120 may have a second diameter D greater than the first diameter d.

A conductive material such as copper and/or aluminum may fill between the inner surface 122 and the outer surface 124 of the second electrode 120. In some embodiments, the second electrode 120 may have flexibility.

The dielectric layer 110 may be disposed between the first electrode 100 and the second electrode 120. The dielectric layer 110 may have a cross section of a ring-shape. A center of the dielectric layer 110 may be substantially the same as the center of the first electrode 100 when viewed from the cross section of the dielectric layer 110. In some embodiments, the dielectric layer 110 may have flexibility.

According to some embodiments of the inventive concept, the dielectric layer 110 may include a polymer using xylene as a monomer. For example, the monomer included in the dielectric layer 110 may be at least one of the following;

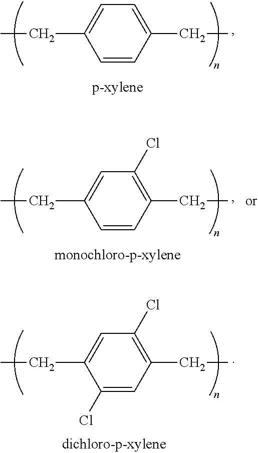

The dielectric layer 110 including the polymer using the xylene as the monomer may have a resistivity of about 10¹⁶ Ωcm or more, a dielectric constant of about 2.95 at about 1 MHz, and a differential impedance having a range of about 90Ω to about 110Ω. Thus, the cable including the dielectric layer 110 may be operated at about 4 Gbps (Giga bit per sec). In some embodiments, the dielectric layer 110 may have a thickness within a range of about 10 μm to about 50 μm.

The dielectric layer 110 may be formed using a chemical vapor condensation (CVC) process. Thus, a conventional high vacuum apparatus or a conventional plasma generation apparatus is not used. As a result, it is possible to improve productivity and to reduce manufacture costs.

### Cable, Second Embodiment

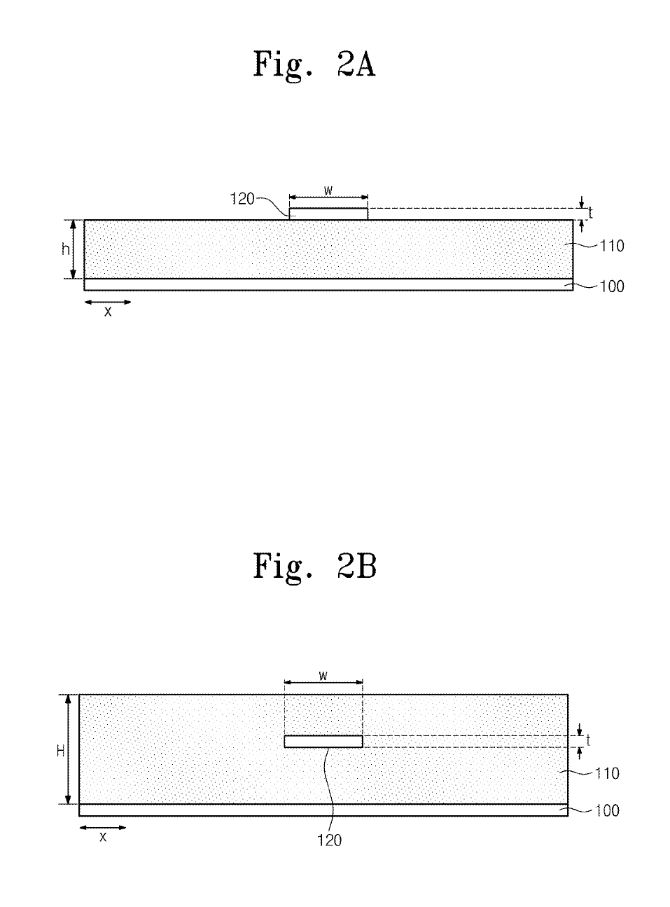

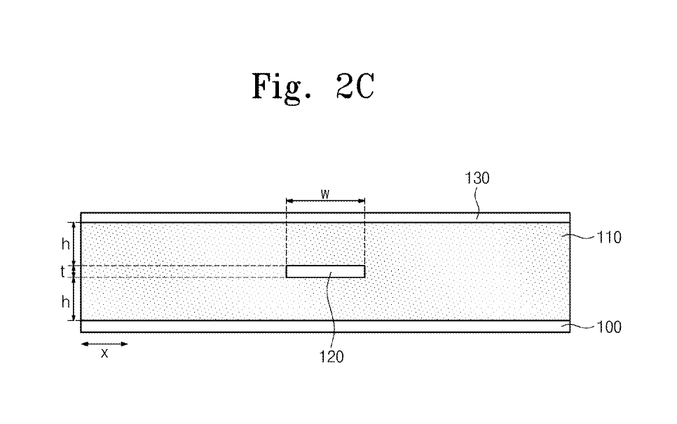

FIGS. 2A to 2C are cross-sectional views illustrating cables according to other embodiments of the inventive concept.

Referring to FIGS. 2A to 2C, a cable may have a plate-shape and extend in one direction. The cable may include a first electrode 100 having a plate-shape, a second electrode 120 having a plate-shape, and a dielectric layer 110 disposed between the first electrode 100 and the second electrode 120. The second electrode 120 may face and be spaced apart from the first electrode 100.

The first electrode 100 may include a short side and a long side. The short side may be parallel to an x-axis direction, and the long side may be parallel to a y-axis direction perpendicular to the x-axis direction in the same plane. Additionally, the long side may extend in substantially the same direction as the extending direction of the cable. The first electrode 100 may include a conductive material of copper or aluminum. In some embodiments, the first electrode 100 may have flexibility.

The second electrode 120 may face and be spaced apart from the first electrode 100. The second electrode 120 may include a short side and a long side. The short side of the second electrode 120 may be shorter than the short side of the first electrode 100. The long side of the second electrode 120 may extend in substantially the same direction as the extending direction of the cable. The second electrode 120 may include a conductive material of copper and/or aluminum. In some embodiments, the second electrode 120 may have flexibility.

The dielectric layer 110 may have one of various structures. Referring to FIG. 2A, the dielectric layer 110 may fill a space between the first and second electrodes 100 and 120. One surface of the dielectric layer 110 may be in contact with one surface of the first electrode 100. Another surface of the dielectric layer 110 may be in contact with one surface of the second electrode 120. Here, the dielectric layer 110 may be formed to expose sidewalls of the second electrode 120.

A dielectric layer 110 illustrated in FIG. 2B may be disposed to bury the second electrode 120 on the first electrode 100. In other words, the second electrode 120 may be buried in the dielectric layer 110. One surface of the dielectric layer 110 of FIG. 2B may be in contact with one surface of the first electrode 100, and another surface of the dielectric layer 110 may be in contact with surfaces of the second electrode 120.

Referring to FIG. 2C, the cable may further include a third electrode 130 facing the first electrode 100. The second electrode 120 may be disposed between the first and third electrodes 100 and 130. The third electrode 130 may have the same shape and the same structure as the first electrode 110. The dielectric layer 110 may be disposed between the first and third electrodes 100 and 130. The dielectric layer 110 may be in contact with sidewalls of the second electrode 120. In other words, the second electrode 120 may be buried in the dielectric layer 110. In some embodiments, a spacing distance between the first and second electrodes 110 and 120 may be substantially equal to a spacing distance between the second electrode 120 and the third electrode 130. Thus, a height h of the dielectric layer 110 formed between the first and second electrodes 100 and 120 may be substantially equal to a height h of the dielectric layer 110 formed between the second and third electrodes 120 and 130.

Electrical characteristics of the cables described with reference to FIGS. 1, 2A, 2B, and 2C will be described hereinafter.

The diameter of the first electrode 100 of the cable is represented as ‘d’ and an inside diameter (i.e., the second diameter of the inner surface 122) of the second electrode 120 is represented as ‘D’. ‘ε₀’ denotes a vacuum dielectric constant, ‘εᵣ’ denotes a dielectric constant of the dielectric layer 110, ‘μ₀’ denotes a vacuum magnetic permeability, and ‘μᵣ’ denotes a magnetic permeability of the dielectric layer 110.

A capacitance of the cable of FIG. 1 is represented as the following equation 1. Here, the unit of the capacitance is F/m.

$$C = \frac{2 π ɛ}{ln ( D / d )} = \frac{2 π {ɛ}_{0} {ɛ}_{r}}{ln ( D / d )} \qquad [ Equation 1 ]$$

An inductance L of the cable is represented as the following equation 2. Here, the unit of the inductance is H/m.

$$L = \frac{μ}{2 π} ln ( \frac{D}{d} ) = \frac{{μ}_{0} {μ}_{r}}{2 π} ln ( \frac{D}{d} ) \qquad [ Equation 2 ]$$

An impedance Z₀ of the cable is represented as the following equation 3. Here, the unit of the impedance is Ω.

$${Z}_{0} = \frac{1}{2 π} \sqrt{\frac{{μ}_{0} {μ}_{r}}{{ }_{0 r}}} ln ( \frac{D}{d} ) \qquad [ Equation 3 ]$$

A signal propagation delay T_{pd} of the cable is represented as the following equation 4. Here, the unit of the T_{pd} is ns/m.

T_{pd}=3.333\sqrt{εᵣμᵣ} [Equation 4]

In FIGS. 2A to 2C, a reference designator ‘w’ denotes a width of the short side of the second electrode 120, a reference designator ‘t’ denotes a thickness of the second electrode 120, and a reference designator ‘h’ denotes the height of the dielectric layer 110 between the first and second electrodes 100 and 120. A reference designator ‘H’ denotes a total height of the dielectric layer 110 in FIG. 2B. In FIG. 2C, the height of the dielectric layer 110 between the first and second electrodes 100 and 120 and the height of the dielectric layer 110 between the second and third electrodes 120 and 130 are indicated by the same reference designator ‘h’.

The following table 1 shows the impedances and the signal propagation delays of the cables illustrated in FIGS. 2A to 2C.

TABLE 1

| | Impedance [Ω] | T_{pd} [ns/m] |
|---|---|---|
| The cable of FIG. 2A | $\frac{87}{\sqrt{{ɛ}_{r} + 1.41}} ln ( \frac{5.98 h}{0.8 w + t} )$ | 3.333\sqrt{1.475 εᵣ + 0.67} |
| The cable of FIG. 2B | $\frac{60}{\sqrt{{ɛ}_{rp}}} ln ( \frac{5.98 h}{0.8 w + t} )$ | 0.278\sqrt{εᵣₚ} |
| The cable of FIG. 2C | $\frac{60}{\sqrt{{ɛ}_{r}}} ln ( \frac{1.9 ( 2 h + t )}{( 0.8 w + t )} )$ | 3.333\sqrt{εᵣ} |

(Method of Manufacturing Cable)

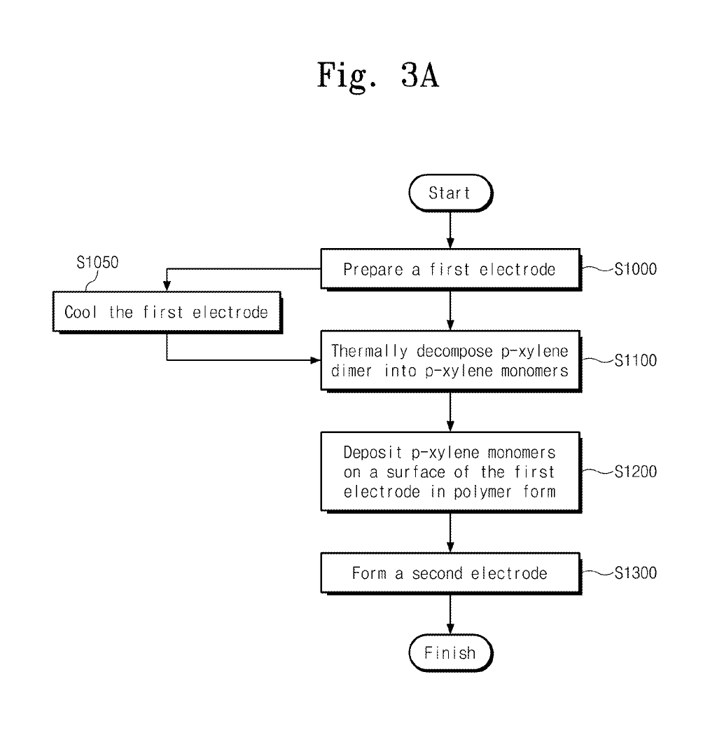

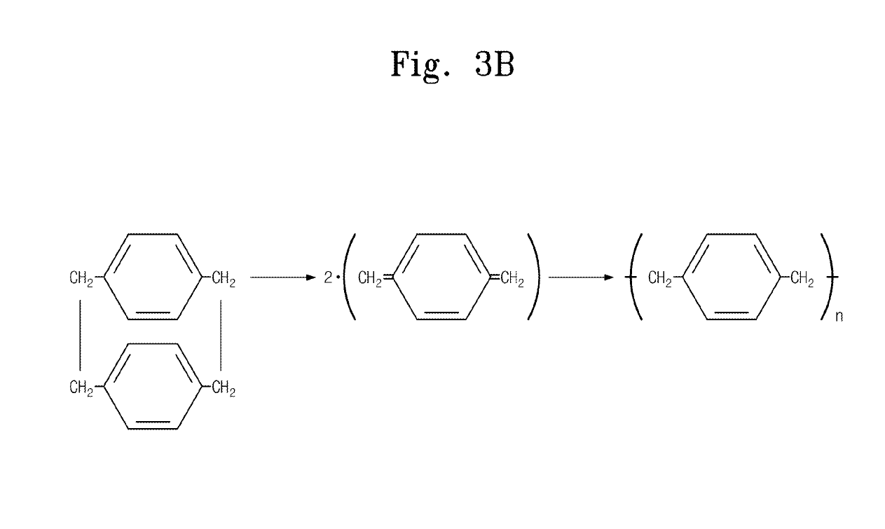

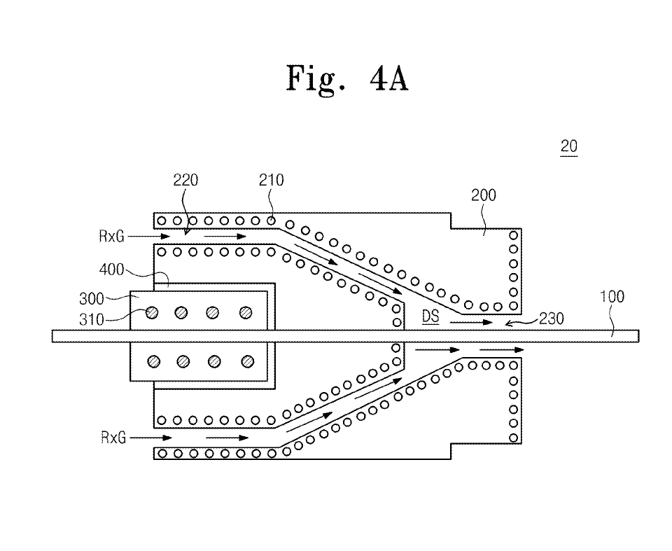

FIG. 3A is a flow chart illustrating a method of manufacturing a cable according to some embodiments of the inventive concept.

Referring to FIG. 3A, a first electrode 100 may be prepared (S1000) and then a dielectric layer 110 may be formed on a surface of the first electrode 100.

In some embodiments, the dielectric layer 110 may include a polymer using xylene as a monomer. For example, the monomer included in the dielectric layer 110 may be at least one of p-xylene, monochloro-p-xylene, and dichloro-p-xylene.

Hereinafter, the dielectric layer 110 including the polymer using p-xylene as the monomer will be described as an example. FIG. 3B illustrates a chemical mechanism of the dielectric layer 100 including p-xylene according to some embodiments of the inventive concept.

Referring to FIG. 3B, p-xylene dimer powder may be heated at a temperature within a range of about 50 degrees Celsius to about 150 degrees Celsius, so that p-xylene dimer may not be melted but be sublimated into gas phase. Subsequently, the sublimated p-xylene dimer may be heated at a temperature within a range of about 650 degrees Celsius to about 700 degrees Celsius to be thermally decomposed into monomers (S1100). P-xylene monomers may be deposited on the surface of the first electrode 100 in polymer form (S1200).

In other embodiments, before the p-xylene monomers are deposited on the surface of the first electrode 100, the first electrode 100 may be cooled at a temperature within a range of about −25 degrees Celsius to about 25 degrees Celsius (S1050). Since the first electrode 100 is cooled at the temperature within a range of about −25 degrees Celsius to about 25 degrees Celsius, a deposition rate of the p-xylene monomers may increase and the p-xylene monomers may be uniformly deposited on the surface of the first electrode 100.

Referring to FIG. 3A again, a second electrode 120 may be formed on a surface of the dielectric layer 110 (S1300).

The first electrode 100, the dielectric layer 110, and the second electrode 120 of the cable may have the same center in a cross-sectional view. Apparatuses for depositing the dielectric layer 110 on the surface of the first electrode will be described in detail hereinafter.

### Apparatus for Depositing Dielectric Layer, First Embodiment

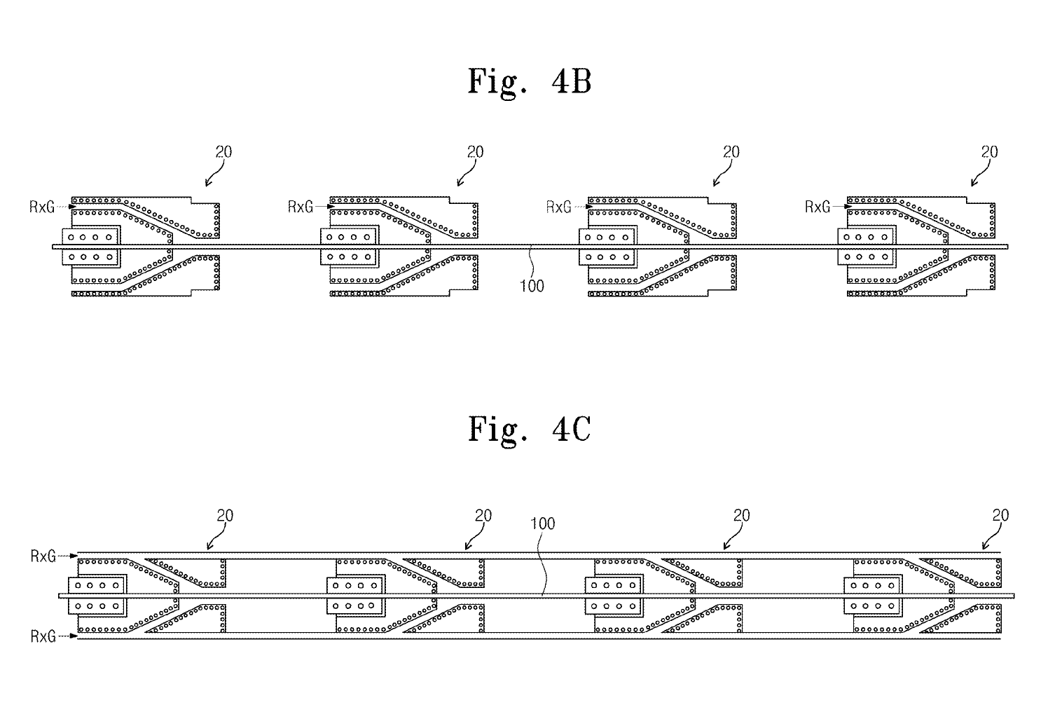

FIGS. 4A to 4C are cross-sectional views illustrating dielectric layer-deposition apparatuses according to some embodiments of the inventive concept.

Referring to FIG. 4A, an apparatus 20 for depositing a dielectric layer (hereinafter, referred to as ‘a dielectric layer-deposition apparatus’) may include a heating block 200 and a cooling block 300.

The heating block 200 may include a reactant injection hole 220 into which a reacting fluid RxG is provided, and an insertion hole 230 in which an object 100 is disposed. The dielectric layer is formed on the object 100. The reactant injection hole 220 may be connected to the insertion hole 230. A connecting part between the reactant injection hole 220 and the insertion hole 230 may correspond to a deposition space DS. The dielectric layer is deposited on the object 100 in the deposition space DS.

In some embodiments, the reacting fluid RxG may include xylene dimer. For example, the reacting fluid RxG may include at least one of p-xylene dimer, monochloro-p-xylene dimer, and dichloro-p-xylene dimer. The reacting fluid RxG may be injected into the reactant injection hole 220 with carrier gas. The carrier gas may include low reactivity gas such as argon (Ar), nitrogen (N₂), and/or helium (He). The object 100 may correspond to an electrode including copper and/or aluminum. A shape of the electrode 100 may be a cylinder-shape or a plate-shape. A shape of the insertion hole 230 may be substantially the same as the shape of the object 100.

In some embodiments, the reactant injection hole 220 in the heating block 200 may have a tapered shape. Due to the reactant injection hole 220 having the tapered shape, the reacting fluid RxG may be prevented from remaining when the reacting fluid RxG and the carrier gas are moved from the reactant injection hole 220 to the insertion hole 230.

The heating block 200 may further include a plurality of heating wires 210. The reacting fluid RxG may be heated and thermally decomposed by the heating wires 210. The heating wires 210 may be disposed to be adjacent to the reactant injection hole 220 and the insertion hole 230. The heating wires 210 may be heated to temperatures different from each other, respectively. For example, the wires 210 disposed to be adjacent to the deposition space DS may be heated to a temperature within a range of about 650 degrees Celsius to about 700 degrees Celsius. Since the deposition space DS is heated to the temperature within the range of about 650 degrees Celsius to about 700 degrees Celsius, xylene dimer may be thermally decomposed into form xylene monomers. The wires adjacent to an end of the reactant injection hole 220 and an end of the insertion hole 230 may be heated to a temperature within a range of about 50 degrees Celsius to about 150 degrees Celsius. Since the wires 210 of the heating block 200 maintain the temperature of about 50 degrees Celsius or more, it is possible to suppress that the reacting fluid RxG is deposited on inner surfaces of the reactant injection hole 220 and the insertion hole 230.

In the present embodiment, the wires 210 may be applied to a heating tool of the heating block 200. However, the inventive concept is not limited thereto.

The cooling block 300 may be disposed within the heating block 200. The cooling block 300 and the heating block 200 may constitute one body. A heat insulating material 400 may be disposed between the cooling block 300 and the heating block 200. Thus, heat conduction between the cooling block 300 and the heating block 200 may be suppressed to prevent or minimize heat loss.

The insertion hole 230 may extend into the cooling block 300. A cooling tool 310 may be disposed to be adjacent to the insertion hole 230. Cooling water or a peltier module may be applied to the cooling tool 310 in the cooling block 300. However, the inventive concept is not limited thereto.

The object 100 disposed in the insertion hole 230 may be moved from the cooling block 300 to the heating block 200. Since the cooling block 300 lowers a temperature of the object 100, deposition efficiency of the dielectric layer on the object 100 may be increased. The cooling tool 310 of the cooling block 300 may cool the object 100 to a temperature within a range of about −25 degrees Celsius to about 25 degrees Celsius.

Referring to FIG. 4B, a plurality of dielectric layer-deposition apparatuses 20 may be arranged on one object 100. The plurality of dielectric layer-deposition apparatuses 20 may be spaced apart from each other by a predetermined distance.

Referring to FIG. 4C, a plurality of dielectric layer-deposition apparatuses 20 may be spaced apart from each other by a predetermined distance, and reactant injection holes 220 respectively included in the plurality of dielectric layer-deposition apparatuses 20 may be connected to each other.

As described above, the plurality of dielectric layer-deposition apparatuses 20 may be used to one object 100, such that it is possible to improve deposition rate and productivity of the process depositing the dielectric layer on the object 100.

### Dielectric Layer-Deposition Apparatus, Second Embodiment

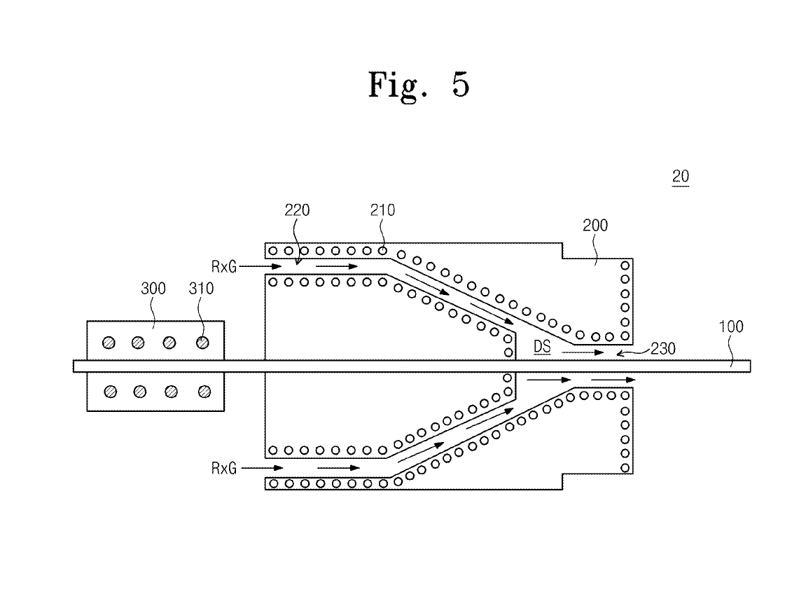

FIG. 5 is a cross-sectional view illustrating a dielectric layer-deposition apparatus according to other embodiments of the inventive concept.

Referring to FIG. 5, a dielectric layer-deposition apparatuses 20 may include a heating block 200 and a cooling block 300.

In the present embodiment, the cooling block 300 may be separated from the heating block 200. In other words, the cooling block 300 may be disposed outside the heating block 200. The other elements and/or the other functions of the dielectric layer-deposition apparatuses 20 in the present embodiment of FIG. 5 may be substantially the same as those of the dielectric layer-deposition apparatuses 20 illustrated in FIG. 4A. In the present embodiment, since the cooling block 300 is separated from the heating block 200, the heat insulating material 400 of FIG. 4A may not be required.

According to embodiments of the inventive concept, the dielectric layer including the polymer having xylene as the monomer may be applied to the cable. Thus, the cable having excellent electrical characteristics may be realized. Additionally, since the dielectric layer is deposited on the first electrode using the apparatus including the heating block and the cooling block, plasma or vacuum may be required during the formation of the dielectric layer. Thus, the dielectric layer may be easily and efficiently formed.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A cable comprising:
a first electrode;
a second electrode spaced apart from the first electrode; and
a dielectric layer disposed between the first and second electrodes, the dielectric layer including a polymer having xylene as a monomer.

2. The cable of claim 1, wherein the dielectric layer includes the polymer having at least one of p-xylene, monochloro-p-xylene, and dichloro-p-xylene as the monomer.

3. The cable of claim 1, wherein the dielectric layer has a thickness within a range of about 10 μm to about 50 μm and a resistivity of about 10¹⁶ Ωcm or more.

4. A method of manufacturing a cable, comprising:
preparing a first electrode;
decomposing xylene dimer into xylene monomers to provide the xylene monomers on a surface of the first electrode;
forming the xylene monomers into a polymer on the surface of the first electrode, thereby forming a dielectric layer including the polymer; and
forming a second electrode on a surface of the dielectric layer.

5. The method of claim 4, wherein decomposing the xylene dimer includes:
thermally decomposing the xylene dimer at a temperature within a range of about 650 degrees Celsius to about 700 degrees Celsius to form the xylene monomers, wherein the xylene dimer includes at least one of p-xylene dimer, monochloro-p-xylene dimer, and dichloro-p-xylene dimer.

6. The method of claim 4, further comprising:
cooling the first electrode to a temperature within a range of about −25 degrees Celsius to about 25 degrees Celsius.

7. An apparatus for depositing a dielectric layer, comprising:
a heating block including a reactant injection hole into which a reacting fluid is provided, an insertion hole connected to the reactant injection hole, and a heating tool, wherein an object is disposed in the insertion hole; and
a cooling block disposed to be adjacent to the heating block and including a cooling tool,
wherein the insertion hole extends into the cooling block; and
wherein a deposition space is defined in a region where the reactant injection hole meets the insertion hole.

8. The apparatus of claim 7, wherein the reactant injection hole has a shape tapered toward the deposition space.

9. The apparatus of claim 7, wherein the reacting fluid is provided into the reactant injection hole with carrier gas.

10. The apparatus of claim 7, wherein the heating tool includes a plurality of wires;
wherein the wires adjacent to the deposition space are heated to a first temperature; and
wherein the wires adjacent to an end of the reactant injection hole and an end of the insertion hole are heated to a second temperature lower than the first temperature.

11. The apparatus of claim 7, wherein the cooling tool includes cooling water or a peltier device.

12. The apparatus of claim 7, wherein the cooling block is disposed within the heating block,
the apparatus, further comprising:
a thermal insulating material disposed between the cooling block and the heating block.

13. The apparatus of claim 7, wherein the apparatus for depositing the dielectric layer is provided in plural; and
wherein the plurality of the apparatuses are disposed on the object and are spaced apart from each other.

14. The apparatus of claim 13, wherein the reactant injection holes respectively included in the plurality of the apparatuses are connected to each other.
